(19) United States
(12) Patent Application Publication
(10) Pub. No.: US 2006/0082994 A1
(43) Pub. Date: Apr. 20, 2006

(54) LED lamp

(75) Inventors: Bily Wang, Hsin Chu City (TW); Jonnie Chuang, Chiao City (TW); Ching-Hung Ko, Tainan City (TW); Chun-Cheng Weng, Yuan Hsien (TW)

Correspondence Address: TROXELL LAW OFFICE PLLC;SUITE 1404, 5205 LEESBURG PIKE, FALLS CHURCH, VA, 22041, US

(73) Assignee: Harvatek Corporation

(21) Appl. No.: 10/965,852

(22) Filed: Oct. 18, 2004

(51) Int. Cl. B60Q 1/26

(52) U.S. Cl. 362/227

(57) ABSTRACT

An LED lamp uses a plurality of LEDs as a light source. The LED lamp has a casing, a conduction layer, a PCB, a plurality of LED and a drive electronics. The conduction layer is placed in an inner of the casing. The conduction layer is metal, copper or aluminum, or nonmetal, silica gel or mica, for conducting the heat of the PCB caused by the current heating effects. The PCB placed on an upper surface of the conduction layer is for mounting the LED. Each LED is electrically connected to the PCB by way of shunt winding or in series for providing a light source. The drive electronics is electrically connected to the PCB for driving color rendering.

### BACKGROUND OF THE INVENTION

1. Field of the Invention

The present invention relates to an LED lamp, and more particularly, to a lamp that uses a plurality of LEDs as a light source.

2. Description of the Related Art

A conventional lamp uses fluorescent tubes 20a as a light source. The lighting principle of the fluorescent tube 20a is a violet ray caused by the acceleration concussion of the electron passing through the fluorescent powder spread on the surface of the glass tube. But this kind of lighting mechanism will cause the light source to flash.

FIG. 1 is a composition view of a conventional lamp in accordance with the prior art. The conventional lamp includes a casing 10a, a fluorescent tube 20a and an electronic ballast 30a. The electronic ballast 30a is for improving the flashing problem of the fluorescent tube 20a. But its price is more than double that of the conventional fluorescent tube 20a. Almost all lamps use the electronic ballast 30a to improve the flashing problem of the fluorescent tube 20a. Because the electronic ballast 30a is high frequency lighting, the light wave is stable and almost non-flashing. When the voltage of the power changes or the fluorescent tube 20a is in a low temperature situation, the lamp is also does not flash as easily, still has the flashing problem. The electronic ballast 30a is also easily disturbed by electromagnetic wave. Furthermore, the conventional fluorescent tube 20a has a low color rendering ability. The light thereof is usually monochromatic, and its color temperature is much the same.

### SUMMARY OF THE INVENTION

It is therefore a principal object of the present invention to provide an LED lamp that uses a plurality of LEDs as a light source. Furthermore, the present invention has been accomplished to eliminate the aforesaid problem.

To achieve the above object, one feature of the present invention provides an LED lamp, including a casing, a conduction layer placed in an inner of the casing, a PCB placed on an upper surface of the conduction layer; and a plurality of LED electrically connected to the PCB to form a light source.

To provide a further understanding of the invention, the following detail description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a composition view of a conventional lamp in accordance with prior art;

FIG. 2 is a decomposition view of the preferred embodiment of the present invention;

FIG. 3 is a composition view of the preferred embodiment of the present invention; and

FIG. 4 is a cross-sectional profile of the preferred embodiment.

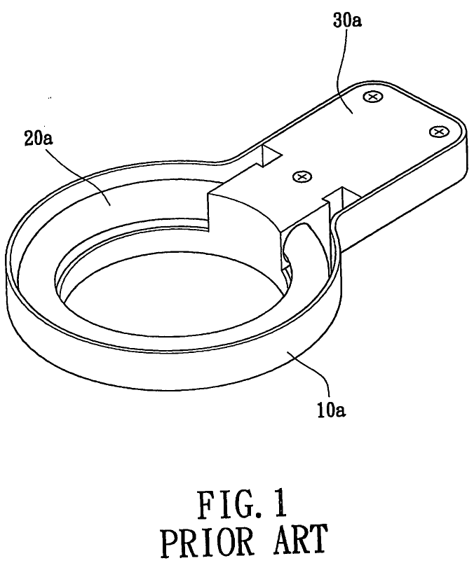

### DETAILED DESCRIPTION OF THE PREFERRED EMBODIMENTS

Reference is now made to the drawings, which are for the purpose of illustrating the preferred embodiments of the present invention only, and not for the purpose of limiting the same.

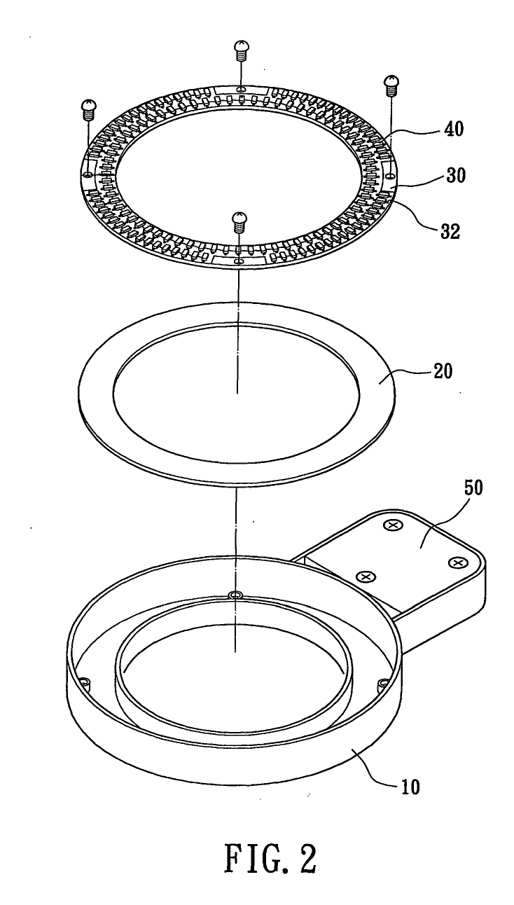

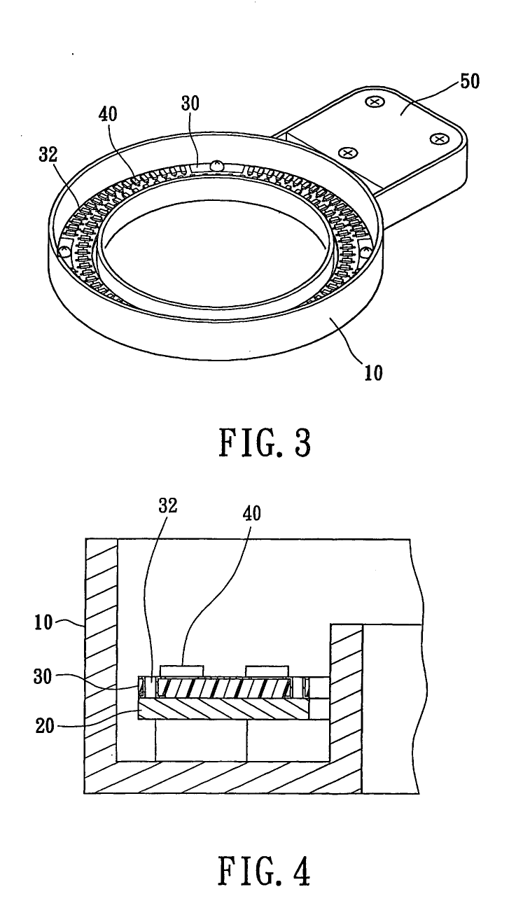

Referring to FIG. 2, FIG. 3 and FIG. 4, the present invention provides an LED lamp including a casing 10, a conduction layer 20, a PCB 30, a plurality of LED 40 and drive electronics 50.

The casing 10 includes an annular concave groove as a fixing pedestal. The casing 10 is a metal or plastic casing with holes for the purpose of the radiation. The conduction layer 20 and the PCB 30 both are placed in an inner portion of the casing 10.

The conduction layer 20 placed between the casing 10 and the PCB 30 is an annular thin metal or nonmetal. The conduction layer 20 is a metal, such as, for example, copper or aluminum, or a nonmetal, such as, for example, silica gel or mica. The conduction layer 20 is for conducting the heat of the PCB 30 produced by the current heating effects. The heat is conducted to the casing 10. The heat radiates through the casing 10 to avoid detrimental overheating.

The PCB 30 is placed on the upper surface of the conduction layer 20. The PCB 30 has a plurality of feed through holes 32 providing radiation to conduct the heat of the PCB 30 to the conduction layer 20. The PCB 30 is, for example, rigid PCB or flexible PCB. The PCB 30 is for fixing the LED 40. The LED 40 is an SMT (surface mount technology)-type LED for mounting on the surface of the PCB 30. The LED 40 can also be, for example, an RGB LED. The LED 40 is electrically connected to the PCB 30 by the way of shunt winding or in series for providing the light source.

The drive electronics 50 is electrically connected to the PCB 30. It is placed on the side of the casing 10 to drive the different color rendering.

The present invention has the following characteristic:

1. The present invention uses the RGB LED as the light source for avoiding the shortcoming of the conventional lamp using the fluorescent tube as monochromatic light. The present invention thus has the advantage of driving different color renderings.

2. The present invention uses the LED as the light source to replace the conventional fluorescent tube. It does not have the flashing problem of the conventional fluorescent tube. The present invention thus has the advantage of providing a stable light source.

There has thus been described a new, novel and heretofore unobvious LED lamp eliminating the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An LED lamp comprising:
a casing;
a conduction layer placed in an interior of the casing;
a PCB placed on an upper surface of the conduction layer; and
a plurality of LEDs electrically connected to the PCB, forming a light source.

2. The LED lamp of claim 1, wherein the casing is an annular concave groove.

3. The LED lamp of claim 1, wherein the casing is a metal or plastic casing with holes.

4. The LED lamp of claim 1, wherein the conduction layer serves as a material for conducting heat and is a metal, copper or aluminum, or a nonmetal, silica gel or mica.

5. The LED lamp of claim 1, wherein the PCB is a rigid PCB or a flexible PCB.

6. The LED lamp of claim 1, wherein the PCB has a plurality of feed through holes.

7. The LED lamp of claim 6, wherein the feed through holes are radiating heat holes.

8. The LED lamp of claim 1, wherein the LED is a SMT (surface mount technology)-type LED.

9. The LED lamp of claim 1, wherein the LED is an RGB LED.

10. The LED lamp of claim 1, wherein the PCB is electrically connected to a driver.
